(19) United States
(12) Patent Application Publication
(10) Pub. No.: US 2010/0048975 A1
(43) Pub. Date: Feb. 25, 2010

(54) Large-volume elimination of airborne chemical and biological warfare agents by making use of a microwave plasma burner

(76) Inventors: Han Sup Uhm, Potomac, MD (US); Dong H. Shin, Seoul (KR); Yong C. Hong, Inchon (KR)

Correspondence Address: Han Sup Uhm, 11613 Swains Lock Terrace, Potomac, MD, 20854, US

(21) Appl. No.: 11/409,011

(22) Filed: Apr. 24, 2006

(51) Int. Cl. A62D 3/19; H05H 1/30; B01J 19/08

(52) U.S. Cl. 588/311; 219/121.55; 219/121.59

(57) ABSTRACT

The invention is related to an apparatus made of microwave plasma burner for a large-volume elimination of toxic airborne chemical and biological warfare agents. The apparatus can purify the interior air of large volume in an isolated space such as buildings, public transportation systems, and military vehicles contaminated with chemical and biological warfare agents. The apparatus consists of a microwave plasma torch connected in series to a fuel injector and a reaction chamber for elimination and burnout of toxic airborne warfare agents in large quantities. Hydrocarbon fuel in gaseous or liquid state injected into the microwave plasma torch evaporates instantaneously, generating a large volume of plasma flame in the reaction chamber where the oxidation mechanism eliminates the chemical and biological warfare agents that pass through the reaction chamber. The apparatus can also purify air contaminated with volatile organic compounds and eliminate soot from diesel engines.

Reference Cited: U.S. Patent Documents

U.S. Pat. No. 5,468,356 November 1995 Uhm

U.S. Pat. No. 6,620,394 B2 September 2003 Uhm et al.

U.S. Pat. No. 6,806,439 B2 October 2004 Uhm and Hong

### FIELD OF THE INVENTION

The present invention relates generally to pollutant abatement and, in particular, to an apparatus and process for eliminating and burning out pollutants in the interior air of large volume in an isolated space such as buildings, public transportation systems, and military vehicles contaminated by chemical and biological warfare agents. The chemical and biological warfare contaminants are eliminated in large amount by their exposure to the flames of the microwave plasma burner.

### BACKGROUND OF THE INVENTION

The chemical and biological warfare agents for mass killing can be used for military conflict and domestic terrorist attack. Therefore, the threat of chemical and biological warfare agents is not only a national issue but also international problem. In this context, protecting people against these warfare agents is very important and necessary in the present world environment. The essential and perfect solution for protection against airborne toxic materials and for prevention of environmental contamination due to spray of the chemical and biological warfare agents is a complete decomposition or a near perfect incineration of the agents.

The purpose of the present invention is a rapid and effective elimination of toxic substances in the interior air in an isolated space such as buildings, public transportation systems, and military vehicles. The buildings, where the interior air must be purified, can be the personal dwellings, apartment buildings, office buildings, school buildings, government buildings, and the commercial buildings. The public transportation system includes automobiles, cars, buses, trains, ships, commercial airline airplanes, and the subway railroad system. The military vehicles mentioned are military trucks, armored personnel carriers, military buses, tanks, military ships, airplane carries, helicopters, and military airplanes.

The unused toxic warfare-agents have been traditionally destroyed by incinerators, which tend to be large, inefficient, and expensive. These incinerators may not be suitable for decontamination of airborne chemical and biological warfare agents in a closed space because of their volume and weight, and because of their secondary contamination due to the incineration. In this context, apparatus made of atmospheric-pressure microwave-plasma torches for elimination of toxic airborne chemical and biological warfare agents was proposed in U.S. Pat. No. 6,806,439 B2 issued to Uhm and Hong, two of the present inventors, on Oct. 19, 2004. In that invention, several microwave plasma torches are connected in series for elimination and burnout of toxic airborne warfare agents. The microwave radiations in that invention generate an atmospheric plasma torch in certain conditions and the oxidation mechanism in the torch flames eliminates the chemical and biological warfare agents. However, that invention can purify about 1000 liters per minute (lpm) contaminated air, which may not be enough for a fast decontamination of a large enclosed space. The reason for the decontamination limitation is small volumes of torch plasma in that invention.

In order to overcome difficulties of the microwave plasma torch caused by a small torch-plasma volume, Uhm et al proposed a new device called microwave plasma burner in U.S. patent application Ser. No. 11/172968 on Jul. 5, 2005. The microwave plasma burner in this pending invention consists of the microwave torch device and fuel injectors, injecting gaseous, liquid or solid-powder hydrocarbon-fuels into the microwave plasma torch, instantaneously decomposing the hydrogen and carbon containing fuels by high temperature of plasma torch, mixing the resultant gaseous hydrogen and carbon compounds with air or oxygen gas instantaneously and generating a large volume of high-temperature plasma flame.

The present invention is made of concept of the microwave plasma burner that injects a large volume of high-temperature plasma flame into a compact reaction chamber through which the contaminated air passes. The high temperature and radicals in the plasma flame in the reaction chamber eliminate the toxic agents in the passing air. Also considered here is the compactness and lightweight of the decontamination apparatus for quick and easy applications in life-threatening situations.

It is therefore an important object of the present invention to optimize the fuel injection system so that the injected fuel molecules contact the high temperature torch and decompose effectively without interfering the plasma torch mechanism.

Other object of the present invention is the residence time of the warfare agents in the reaction chamber in order to achieve elimination of toxic warfare agents in a carrier gas by exposure to a plasma flame generated by the microwave plasma burner.

Another object of the present invention is to simultaneously provide an elimination and burnout system that is effective against a wide range of chemical and biological warfare agents with a microwave plasma burner connected to a reaction chamber.

Additional object is to overcome difficulties heretofore experienced in achieving efficient and rapid elimination of the toxic agents by oxidation with a microwave plasma torch connected in series to a fuel injector and an appropriate reaction chamber.

Further additional objects, advantages and novel features of the invention will be explained in part in the following description, and will be apparent to those skilled in the following experiment.

### SUMMARY OF THE INVENTION

The present invention is the apparatus for simultaneous elimination and burnout of chemical and biological warfare agents diluted in air with a microwave plasma torch connected in series to a fuel injector and a reaction chamber. Particularly, the apparatus is useful for purifying the interior air of large volume in an isolated space such as buildings, commercial transportation systems, and military vehicles contaminated with chemical and biological warfare agents. High-energy electrons and other chemically active radicals provided by the plasma torch and plasma flame from fuel combustion are needed to eliminate and burn out chemical and biological warfare agents. The microwave plasma torch is connected in series to a fuel injector and a reaction chamber so that the contaminated air stream to be purified passes through the reaction chamber with the required residence time for best decontamination effect. The high temperature flame in the reaction chamber creates a unique environment for efficient chemical reactions.

In order to eliminate the airborne chemical and biological warfare agents in a large enclosed space, the present invention includes:
a microwave plasma torch system that provides a high temperature plasma torch in a discharge tube;
a fuel injection system that injects hydrocarbon fuels into the plasma in the discharge tube, generates a large volume of plasma flame of the microwave plasma burner and maintains the plasma flame all the way to the exhaust exit;
a reaction chamber connected in series to the flame exit of the microwave plasma burner so that the plasma flame from the flame exit contains in the chamber; and
an air supply system that supplies the contaminated air into the reaction chamber to eliminate the toxic warfare agents in the carrier gas by exposure to the plasma flame in the chamber.

The atmospheric plasma abatement system, which is simple and cost-effective, is the most suitable for purification of air contaminants. The elimination experiment of any chemical warfare agent is almost impossible in an ordinary laboratory due to safety issues. In this context, the experimentalists traditionally carry out a simulated experiment by making use of toluene gas. For same reason, the biological warfare agents are not used in an ordinary laboratory. The airborne biological warfare agents like microbes or bacteria are attached to organic or inorganic aerosols and are spread as the aerosol particles are floating around. Therefore, the elimination of aerosols as the biological simulated agents was carried out.

### BRIEF DESCRIPTION OF DRAWING FIGURES

A more complete appreciation of the invention and many of its attendant advantages will be aided by reference to the following detailed description in connection with the accompanying drawings:

FIG. 1 is a block diagram illustrating the airborne warfare-agent elimination-system of the present invention;

FIG. 2 is a cross-sectional view of the decontamination apparatus of the chemical and biological warfare agents by making use of high-temperature plasma burner.

FIG. 3 is the reaction chamber of the decontamination apparatus.

FIG. 4 is the cross sectional view of the reaction chamber of the decontamination apparatus.

FIG. 5 is the toluene decomposition rate in terms of kerosene injection rate injected into the plasma burner.

FIG. 6 is the toluene decomposition rate in terms of methane injection rate injected into the plasma burner.

FIG. 7 is the leftover toluene-concentration rate in terms of energy density for the kerosene injected into the plasma burner.

FIG. 8 is the leftover toluene-concentration rate in terms of energy density for methane injected into the plasma burner.

FIG. 9 is the hydrogen-sulfide decomposition rate in terms of kerosene injection rate injected into the plasma burner.

FIG. 10 is the hydrogen-sulfide decomposition rate in terms of methane injection rate injected into the plasma burner.

FIG. 11 is the leftover hydrogen-sulfide concentration in terms of energy density for the kerosene injected into the plasma burner.

FIG. 12 is the leftover hydrogen-sulfide concentration in terms of energy density for methane injected into the plasma burner.

FIG. 13 is the leftover soot concentration in terms of energy density where the soot carrier gas is the discharge gas from 10,000 cc diesel bus engine at 800 rpm and the energy source of the reaction chamber is the methane injected into the plasma burner.

### DETAILED DESCRIPTION

The present invention is the apparatus and scheme for a simultaneous elimination and burnout of chemical and biological warfare agents diluted in air with the microwave plasma torch connected in series to a fuel injector and a reaction chamber. The principles and operation of the microwave plasma torch, fuel injection system and the reaction chamber of the present invention are described according to the drawings.

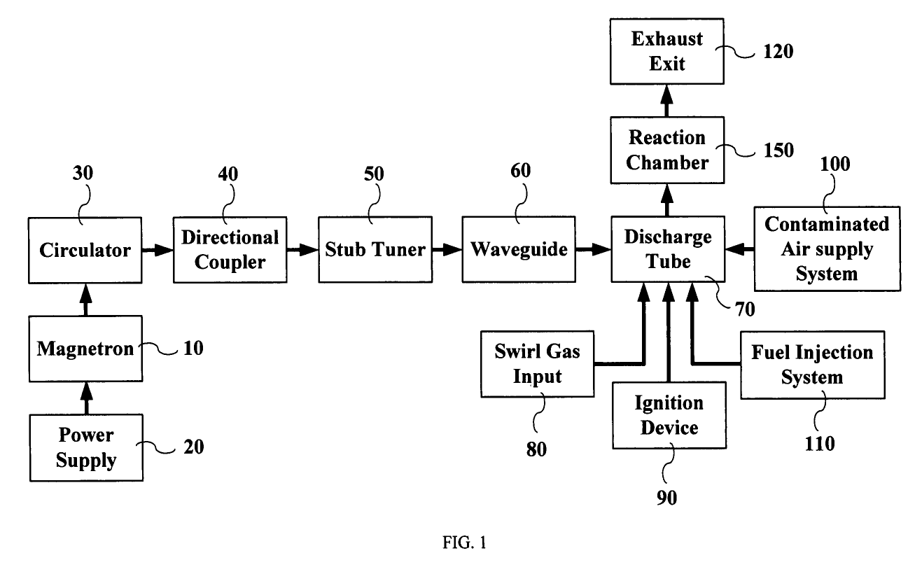

FIG. 1 is a block diagram of the present invention that consists of a magnetron 10, an electrical power supply 20, a circulator 30, a directional coupler 40, stub tuner 50, a waveguide 60, a discharge tube 70, a swirl gas input 80, an ignition device 90, contaminated air supply system 100, fuel injection system 110, a reaction chamber 150 and the exhaust exit 120. The microwave frequency of the aforementioned magnetron is in the range of 10 MHz-10 GHz but the most preferred frequency is 2.45 GHz. The aforementioned electrical power supply 20 is made of a high-voltage pulse or DC power supplier that provides an electrical power to the magnetron 10. The circulator 30 forwards the microwaves from the magnetron 10 and eliminates the reflected waves due to the impedance mismatch for protection of the magnetron 10. The directional coupler 40 displays the forward and reflected microwave intensities and the stub tuner 50 modifies the waveguide impedance so that the most intensive electric field can be induced in the discharge tube 70. A correct adjustment of the stub tuner 50 makes the reflected wave intensity less than 1 percent of the forward wave intensity. The reflected wave intensity is less than 10 percent of the forward wave intensity if the plasma torch is established. The waveguide 60 carries the microwaves from the stub tuner 50 to the discharge tube 70. The discharge tube 70 is located at the end portion of the waveguide 60 and provides the space for plasma generation. The swirl gas input 80 supplies the swirl gas into the discharge tube 70 for stabilization of plasma torch and for protection of inner wall of the discharge tube 70 from torch heat. The ignition device 90 provides the initial electrons for plasma generation. The contaminated air supply system 100 consists of a strong suction fan, supplying 1000˜100,000 liters per minute contaminated air into the reaction chamber 150 through air input port. The fuel supply system 110 injects fuels in gaseous or liquid state into the plasma torch so that a large volume of high-temperature plasma flame can be generated inside the reaction chamber.

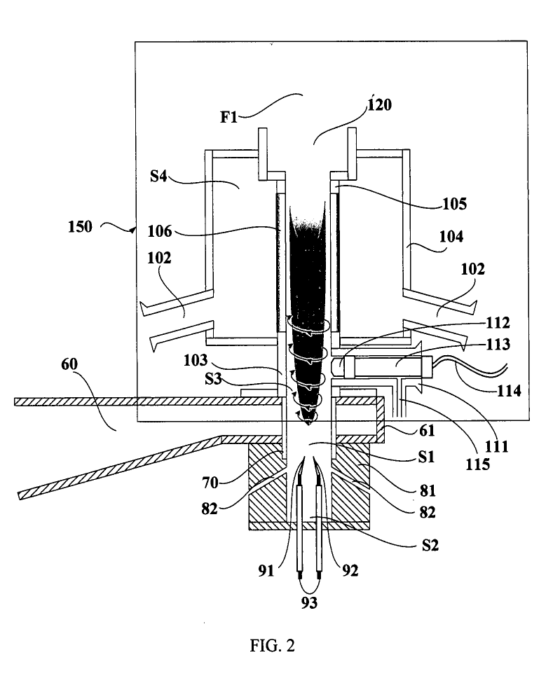

FIG. 2 represents a cross sectional view of the decontamination apparatus of the chemical and biological warfare agents consisted of the waveguide 60, the discharge tube 70, the swirl gas supply 80, the ignition device 90, the fuel injection system 110, and the reaction chamber 150. The reaction chamber has the outer wall 104 of the outer compartment that supports the input port 102 of the contaminated air from the contaminated air supply system 100. Referring to FIG. 2, the waveguide 60 is made originally of the standard rectangular shape with 86 mm width and 43 mm height decreases its cross section area by tapering, as it progresses from the stub tuner 50 to the discharge tube 70, so that the energy density of the input microwave increases to its maximum value at the discharge tube 70. The discharge tube 70 positioned at ⅛˜½ wavelength away from the end of the waveguide 60 penetrates perpendicularly through the waveguide. The optimum distance from the end of the waveguide to the discharge tube 70 is ¼ wavelength and the discharge tube 70 material is preferred to be quartz, alumina or ceramic so that the microwaves can penetrate easily.

The swirl gas input 80, consisted of the first block 81 and the swirl-gas injection tube 82, supplies the swirl gas into the discharge tube 70 to stabilize the plasma torch and to protect the inner wall of the discharge tube 70. The first block 81 provides two spaces S1 and S2 under the discharge tube 70 and holds the bottom part of the discharge tube 70. The first block 81 is made of metal or conducting material to prevent microwave leaking. Several swirl-gas injection tubes 82 locate around the first block 81 with equal angular interval, pointing slightly upward. Angle of the swirl-gas injection tubes 82 is particularly arranged so that the injected gas can be in tangential along the inner wall of the discharge tube 70. The gas injected through the swirl-gas injection tube enters the discharge tube 70 creating a swirl inside the tube 70 and stabilizing the plasma torch. The air blanket of the swirl gas prevents a possible damage caused by torch heat with its maximum temperature of 5,500 degree Celsius. This swirl gas can also be used for oxidation of fuel and toxic material in the contaminated air. The swirl gas can be air, oxygen, nitrogen, argon and a mixture of these gases.

The ignition device 90, consisted of one pair of electrodes 91 and 92 in the discharge tube 70, provides the initial electrons inside the discharge tube 70 for plasma initiation. The electrodes 91 and 91 are wrapped by dielectric tube 93 to prevent any arcing between the electrodes and the first block 81. The distance between the points of the electrodes 91 and 92 is in the range of 0.1-50 mm.

The contaminated air supply system 100 sucks the contaminated air of the flow rate in the range of 1000˜100,000 liters per minute through its suction fan and injects the air into the reaction chamber 150 through several input ports 102. The outer compartment of the reaction chamber provided in the space between the inner compartment wall 105 and the outer wall 104. The air entered into the outer compartment through the wall 104 swirls and passes through several slits 106, entering the inner compartment through the wall 105 of the reaction chamber 150. The slit 106 is in the tangential direction to the inner compartment wall 105 of the reaction chamber 150. The number of the input port 102 and slit 106 is four in an example.

The fuel injection system 110, consisted of the second block 103, fuel injector 111, nozzle 112, nozzle holder 113, fuel supply tube 114 and additional gas supplier 115, provides hydrocarbon fuel in gaseous or liquid state to the plasma torch, creating a large volume of high-temperature plasma flame F1 in the inner compartment 105 of the reaction chamber 150. The high temperature plasma flame F1 oxidizes and decomposes the chemical and biological warfare agents in the contaminated air.

The second block 103, installed above the waveguide 60, is located at the downstream of the discharge tube 70. The space S3 inside the second block 103 is smoothly connected to the space S1 in the discharge tube 70 and also connected to the inner compartment of the reaction chamber 150, which is open to the exhaust exit 120 of the plasma flame F1. The spaces S1, S2 and S3 inside the assembly of the first 81 and second 103 blocks and the discharge tube 70 forms a large space for plasma torch and flame. The second block 103 is made of a metal or conducting material to prevent microwave leaking. The fuel injector 111 injects the hydrocarbon fuel in gaseous or liquid state into the space S3 inside the second block 103. Several fuel injectors 111 are located in the second block 103 with equal angular interval. The hydrocarbon fuel injected by the fuel injector 111 is methane, ethane, propane, butane, kerosene, diesel and gasoline.

The contaminated air enters the outer compartment in the space between the reaction chamber wall 104 and the inner compartment wall 105 through the input port 102 and swirls in the outer compartment, then enters eventually the inner compartment through the slits 106 meeting the high-temperature plasma flame and decomposing the toxic materials by the flame. The contaminated air spends some time in the outer compartment at a medium temperature, being preheated and dissolving some toxic material, and then enters the inner compartment at high temperature, breaking down most of the toxic material.

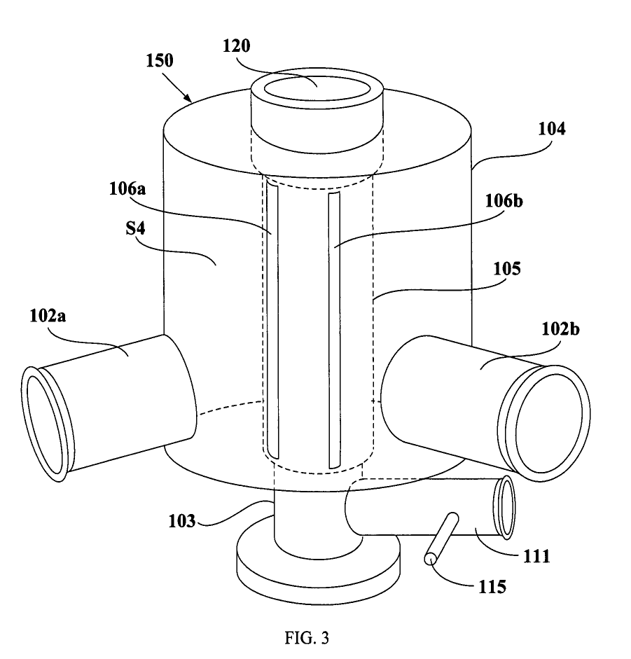

The reaction chamber 150 in FIG. 3 attached to the second block 103 has four input port 102 designated by 102a, 102b, 102c and 102d. The reaction chamber 150 also has the fuel injector 111, the additional gas supplier 115, the outer compartment 104 and inner compartment 105 and four slits 106 designated by 106a, 106b, 106c, and 106d. FIG. 3 shows the exhaust exit 120. The input port 102 is installed to be in the tangential direction of the inner surface of the outer wall 104 and to be slightly upward direction so that the air entered makes a swirl motion inside the outer compartment of the reaction chamber 150.

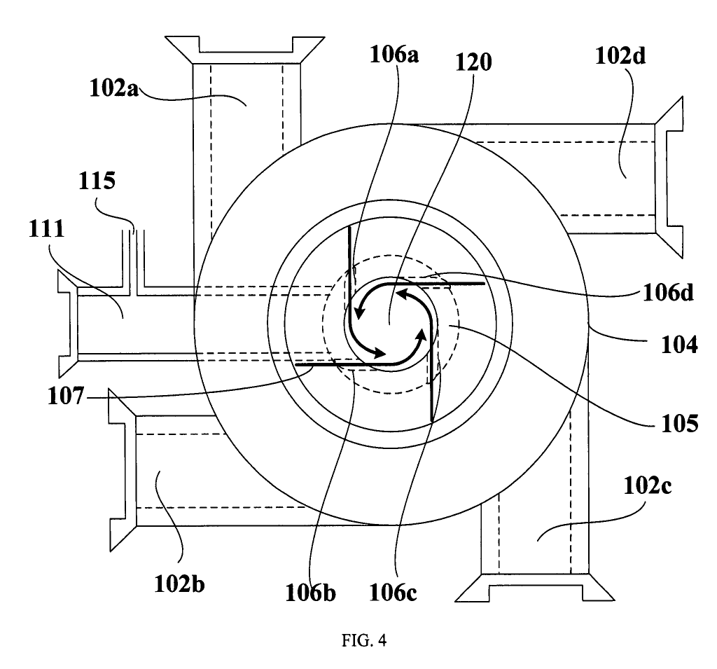

FIG. 4 is the cross sectional view of the reaction chamber in FIG. 3 of the decontamination apparatus. Four input ports 102a, 102b, 102c, and 102d are connected to the outer compartment through the wall 104 of the reaction chamber in the tangential direction and the inner wall 105 has four slits 106a, 106b, 106c, and 106d in the tangential direction of the inner compartment wall. The contaminated air entered through the input port 102 creates a swirl flow 107 in the outer compartment and then enters the inner compartment through the tangential slit 106, meeting the high-temperature plasma flame energized by the fuel from the fuel injector 111 and energized by fresh gas from the additional gas supplier 115. The fuel injector 111 is installed in perpendicular direction to the second block 103 and plasma flame F1.

The plasma flame from the microwave plasma burner vitalizes aforementioned decomposition mechanism of the toxic material, which is explained as follow:

Once the electrical power is supplied from the power supplier 20 to the magnetron 10, the magnetron generates microwaves that propagate forward through the circulator 30, directional coupler 40, the stub tuner 50 and the waveguide 60 arriving on the discharge tube 70, while the swirl gas input 80 injects the swirl gas into the discharge tube 70, creating swirl flow inside the discharge tube 70.

If the microwaves and swirl gas enter the discharge tube 70, the electrodes in the ignition device 90 ignite initial electrons for plasma generation. The swirl gas inside the discharge tube 70 stabilizes the plasma and protects the discharge wall from the torch heat. The hydrocarbon fuel from the fuel injection system 110 enters the plasma from side, creating a large volume of the plasma flame, which decomposes the chemical and biological agents in the contaminated air entered through the air supply system 100 attached to the reaction chamber 150. The treated air exits eventually through the exhaust exit 120. Temperature at the center of the plasma torch is 5000˜6000 degree Celsius so that the liquid fuel evaporates instantaneously and oxidizes so fast, thereby decomposing and burning out the toxic material.

The destruction model of the chemical and biological warfare agents can be expressed as

$$\frac{X}{{X}_{0}} = exp ( - \frac{E}{β} ) , \qquad ( 1 )$$

where X represents the leftover concentration of the warfare agents after the plasma flame treatment and X₀ is the initial concentration before the treatment, E denotes the energy density (in units of joules per liter) deposited on the contaminated air by the plasma flame during the treatment and β represents the energy density required for bringing down the concentration to 1/e of its initial concentration; i.e. the energy density needed for 63% decomposition. Designating R as the flow rate of the contaminated air, we note RE=constant for specified system parameters of the decontamination apparatus. In other words, the energy density E deposited by the plasma flame during the treatment is inversely proportional to the airflow rate R. Assuming that X₁ and X₂ correspond to the leftover concentrations for the flow rates R₁ and R₂, respectively, we find the relationship

$$\frac{{R}_{1}}{{R}_{2}} = \frac{ln ( {X}_{0} / {X}_{2} )}{ln ( {X}_{0} / {X}_{1} )} , \qquad ( 2 )$$

which relates the leftover concentration X to the airflow rate R. We can find the leftover concentration X₂ in terms of R₂ if we know the concentration X₁ in terms of R₁.

### EXAMPLE 1

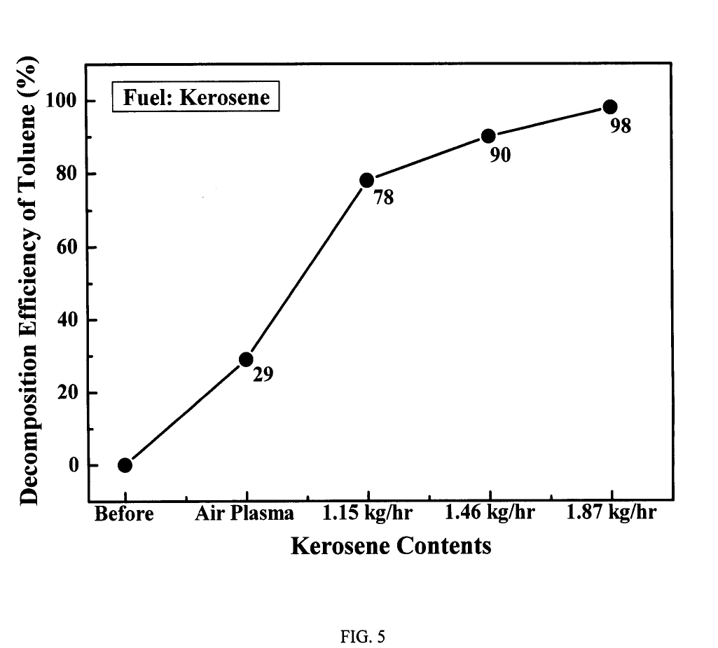

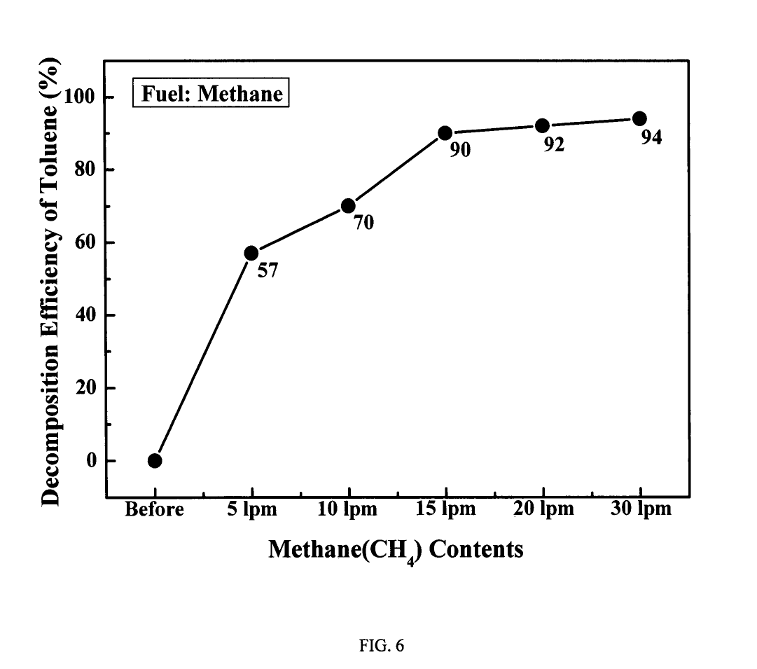

As an example, we used toluene as a simulated chemical warfare agent, and kerosene and methane were used as the hydrocarbon fuels in liquid and gaseous states, respectively. Toluene are evaporated into air and a suction fan supplied the contaminated air of R=5,000 liters per minute (lpm) to the reaction chamber 150. 40 lpm of the compressed air was supplied to the swirl gas input 80. The injection rates of the kerosene in this experiment are 1.15 kg/hr, 1.46 kg/hr and 1.87 kg/hr. 1.15 kg/hr is approximately 0.3 gal/hr. The methane flow rates are 5 lpm, 10 lpm, 15 lpm, 20 lpm and 30 lpm. The microwave power was 1.4 kW and the initial toluene concentration was X₀=170 particulates per million (ppm). The reaction chamber size was measured to be 22 cm diameter and 30 cm long. The compactness and lightweight of the decontamination apparatus are the key issues for quick and easy application in life-threatening situations. Therefore, the reaction chamber must be as small as possible for a specified airflow rate. The reaction chamber of 22 cm diameter and 30 cm length is good for the airflow rate of 5000 lpm. The leftover concentration X of the toluene had been measured by making use of detector tubes made by GASTECH Company in Japan. We may use the gas chromatography (GC) or the Fourier transform infrared (FTIR) to get more accurate data. But we were afraid of getting completely wrong measurement because of peculiar properties of toluene. Remember that toluene is liquid at the room temperature of one atmospheric pressure and the sample can easily be spoiled by condensation. The measurement by detector tubes can be done at the exhaust exit 120 without any delay or any interference. Therefore, the detector tube may reliably measure the leftover toluene, although the data may have a large error bar. FIGS. 5 and 6 are the toluene decomposition rates in terms of the kerosene and methane injection rates, respectively. Each data point in FIGS. 5 and 6 is an average value of 8 repeated measurements. The toluene decomposition rate increases as the fuel injection rate increases. The toluene decomposition rate is more than 90 percent for 1.46 kg/hr kerosene and 15 lpm methane injections.

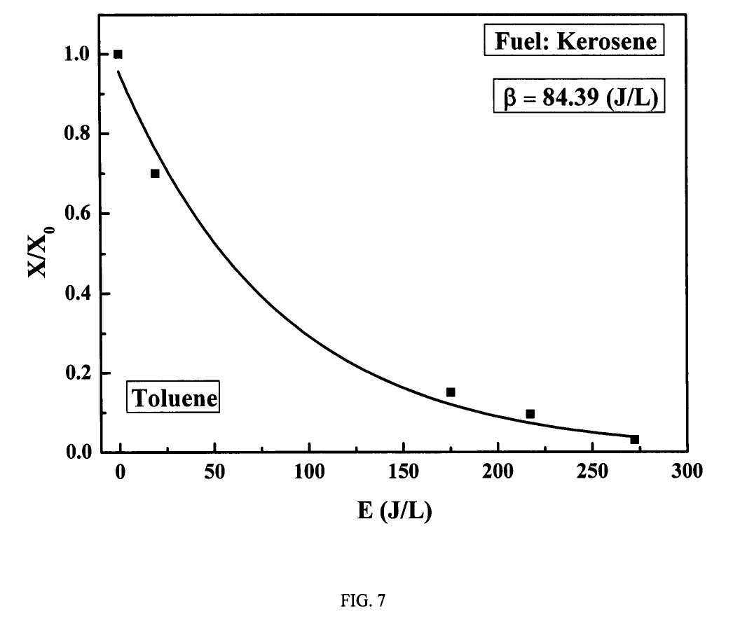

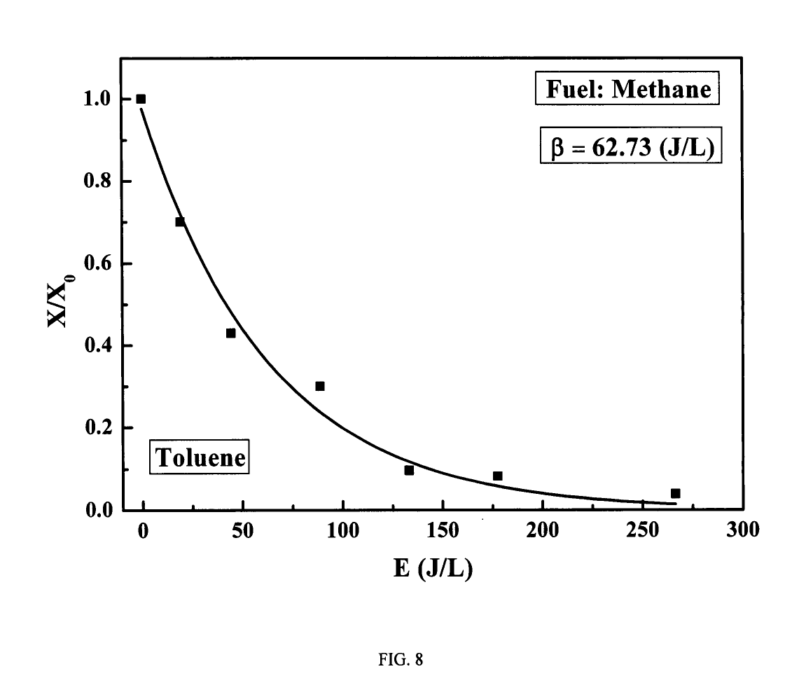

FIGS. 7 and 8 are the leftover toluene-concentration rate in terms of the energy density for the kerosene and methane injected, respectively, into the plasma burner. The energy contained in kerosene is 10⁷ cal/kg and the energy contained in methane is 9.52×10⁶ cal/m³. Using these numbers, the fuel injection rate can be translated into watt. For example, 0.3 gal/hr (1.15 kg/hr) injection rate of kerosene is 1.3×10⁴ W and 20 lpm injection rate of methane is 1.32×10⁴ W. FIGS. 7 and 8 are obtained from FIGS. 5 and 6, expressing the fuel injection rate in terms of the energy density. The curves in FIGS. 7 and 8 were obtained from Eq. (1) with β-value that was least-squared fitted to the data points. The dots at E=16.8 joules per liter (J/L) in FIGS. 7 and 8 correspond to the microwave power of 1.4 kW. The β-value of toluene decomposition is β=84.39 J/L for kerosene and β=62.73 J/L for methane. According to a previous work “Comparison of Pulse Corona and Electron Beam Processing of Hazardous Air Pollutions,” in J. Adv. Oxid. Technol. 2, NO. 2 (1997) by B. M. Penetrante et. al., the β-value of the pulse corona for toluene decomposition is β=393 J/L. According to U.S. Pat. No. 6,806,439 B2 issued to Uhm and Hong on Oct. 19, 2004, the β-value of the microwave plasma torch for toluene decomposition is β=173 J/L. Obviously, the toluene decomposition by the high-temperature plasma flame from plasma burner is far more efficient than that by pulse corona or by microwave torch. Furthermore, the decomposition apparatus made of the microwave plasma burner is very compact and light to be handy for various applications. The temperature of the reaction chamber wall and the exit gas is not hot due to a large amount of airflow. In fact, we can touch the outer wall of the reaction chamber that feels warm.

### EXAMPLE 2

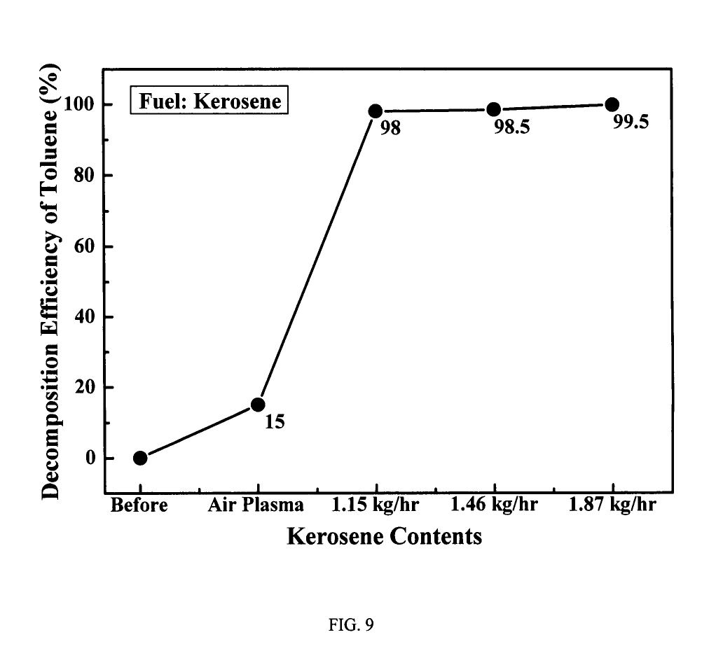

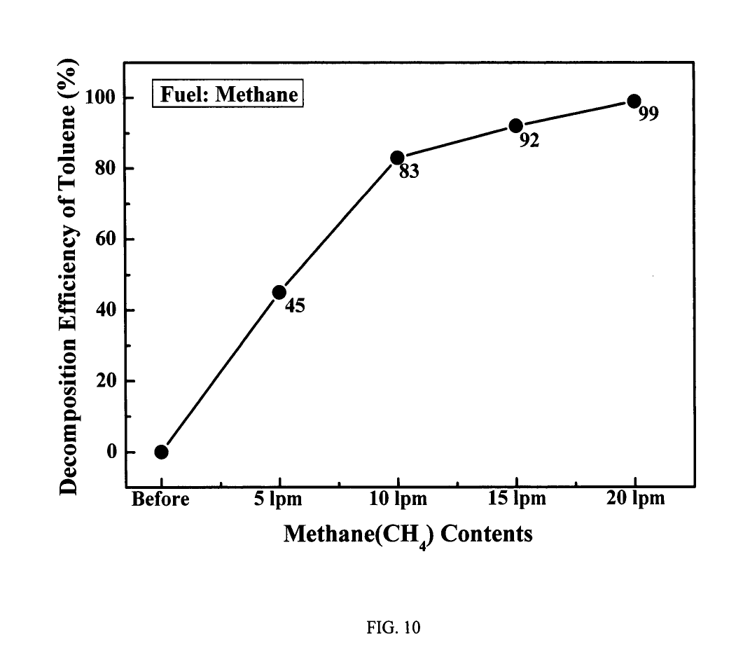

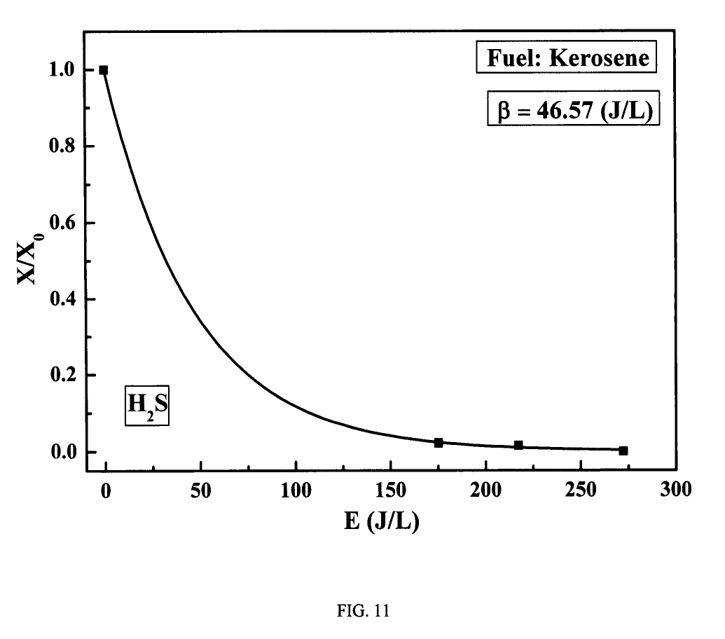

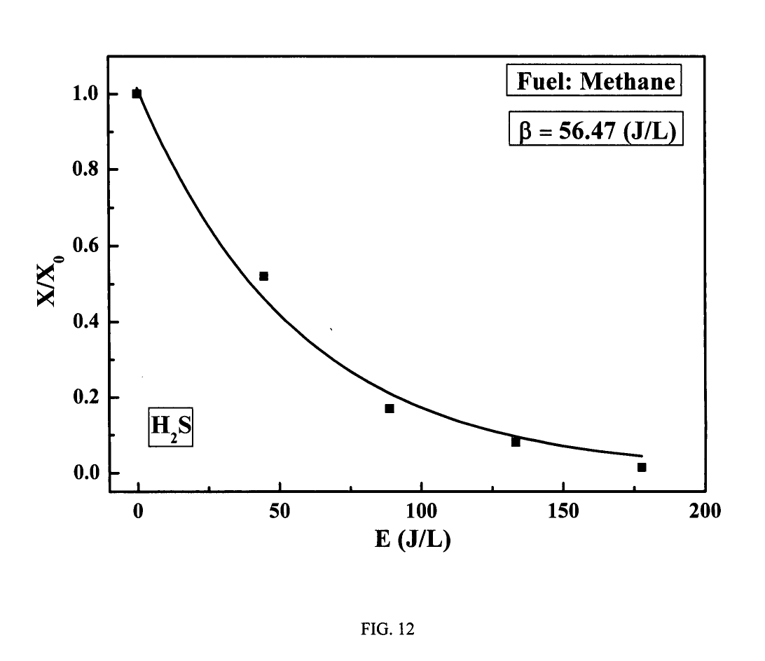

The next example is the decomposition of hydrogen sulfide (H₂S). The hydrogen sulfide molecules are mixed in air and a suction fan supplied the contaminated air of R=5,000 liters per minute (lpm) to the reaction chamber 150. 40 plm of compressed air was supplied to the swirl gas input 80. The injection rates of the kerosene in this experiment are 1.15 kg/hr, 1.46 kg/hr and 1.87 kg/hr. The methane flow rates are 5 lpm, 10 lpm, 15 lpm, and 20 lpm. The microwave power was 1.4 kW and the initial hydrogen-sulfide concentration was X₀=120 ppm. The reaction chamber size was measured to be 22 cm diameter and 30 cm long. The input lines leading to detection apparatus like GC or FTIR can easily absorb the hydrogen sulfide molecules. It is therefore unreliable to use GC or FTIR for measuring concentration of hydrogen sulfide molecules in air. The decomposition data were measured by making use of detector tubes. FIGS. 9 and 10 are the hydrogen-sulfide decomposition rates in terms of the kerosene and methane injection rates, respectively. Each data point in FIGS. 9 and 10 is an average value of 7 repeated measurements. The hydrogen-sulfide decomposition rate increases as the fuel injection rate increases. The hydrogen-sulfide decomposition rate is more than 90 percent for 1.15 kg/hr kerosene and 15 lpm methane injections. FIGS. 11 and 12 are the leftover hydrogen-sulfide concentration in terms of the energy density for the kerosene and methane injected, respectively, into the plasma burner. FIGS. 11 and 12 are obtained from FIGS. 9 and 10, expressing the fuel injection rate in terms of the energy density. The curves in FIGS. 11 and 12 were obtained from Eq. (1) with β-value that was least-squared fitted to the data points. The β-value of hydrogen-sulfide decomposition is β=46.57 J/L for kerosene and β-value=56.47 J/L for methane, which are considerably less than those of toluene decomposition. Hydrogen-sulfide decomposition is easier than toluene decomposition in the microwave plasma burner. In this context, the decontamination apparatus in the present invention can also be useful for decontamination of industrial pollutants.

### EXAMPLE 3

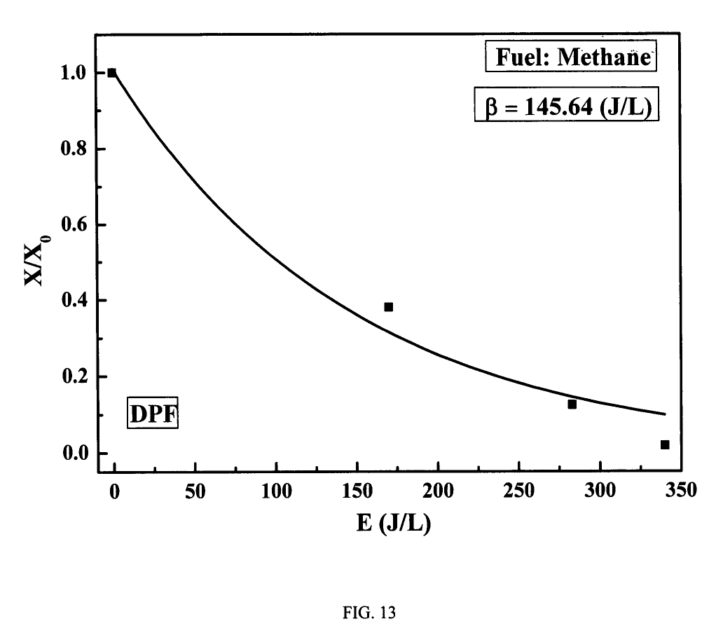

Elimination experiment of the airborne biological warfare agents is very hard because of difficulty of detecting the agents before and after the plasma flame treatment. Spores of the biological warfare agents are usually attached to aerosol particles. Elimination of aerosol particles may indirectly show the elimination of airborne biological warfare agents. Elimination of soot from diesel engine, which can be seen as airborne aerosol particles, was observed in this example. The kerosene burning may generate its own soot, which may interfere the observation of diesel engine soot so that the gaseous fuel of methane was used in the experiment. The methane injection rate was 15 lpm, 25 lpm and 30 lpm. The discharge gas from 10,000 cc bus diesel engine at 800 rpm was used for contaminated air with soot. The airflow rate at the engine exit is 8,000 lpm, which is estimated to be 3,500 lpm at the end of the tail pipe due to cooling of the ambient air. The energy density therefore was calculated by the methane injection into the airflow of 3,500 lpm. White filters captured soot from the discharge gas. A smoke meter from BOSCH, which determines opacity, measured the captured soot-amount in the filter. The remaining soot in relative to the untreated case is plotted in FIG. 13 in terms of the energy density for methane injected into the plasma burner. The soot are almost completely eliminated at E=340 J/L corresponding to 30 lpm methane injection. The β-value of the soot elimination was determined by the least-squared-fitted to the experimental data in FIG. 13 and is given by β=145.64 J/L. We conclude from FIG. 13 that the plasma flame in the present invention is an effective means to eliminate soot from diesel engine. This means that the decontamination apparatus of the present invention may be very useful for airborne aerosol particles. Most of the aerosols are made of hydrocarbon materials, which can easily be oxidized at high-temperature plasma flame with temperature higher than 500 degree Celsius. The biological agents consisted of bacteria and virus may not survive as they go though high temperature flame. Therefore, the plasma flame of the present invention may effectively eliminate the airborne biological warfare agents. A different experimental observation confirmed that the plasma flame of kerosene or diesel fuel injected into the plasma burner does not produce its own soot. In this context, the present invention can also be useful for elimination of soot from diesel engines in trucks, in buses, in trains and in ships.

We also note from Eq. (2) that the airflow rate can increase by suffering decomposition rate. For example, the leftover toluene concentration at kerosene fuel rate of 1.87 kg/hr in FIG. 7 is X₁/X₀=0.02 for R₁=5,000 lpm. Substituting these numbers into Eq. (2), we find R₂=19,560 lpm for X₂/X₀=1/e. About 20,000 lpm of contaminated air with toluene can be treated if the treatment is required to be 63 percent elimination. As other example, the leftover hydrogen-sulfide concentation at kerosene fuel rate of 1.87 kg/hr in FIG. 11 is X₁/X₀=0.001 for R₁=5,000 lpm. Substituting these numbers into Eq. (2) gives R₂=34,540 lpm for X₂/X₀=1/e, which means 35,000 lpm airflow for 63 percent decomposition of hydrogen sulfide concentration.

As mentioned earlier, the compactness and lightweight of the decontamination apparatus are critical issues for field application due to fast mobility and quick installation in life threatening situation. The reaction chamber size used in the experiments in examples 1, 2, and 3 presented earlier is 22 cm diameter and 30 cm long, which limits the airflow rate. Linear dimension of the waveguide and discharge tube in the microwave torch system is proportional to the wavelength of microwave. Therefore, the torch plasma volume is inversely proportional to the square of the microwave frequency. For example, the torch plasma volume increases 7 times by changing the microwave frequency from 2.45 GHz to 915 MHz with additional power. The larger the reaction chamber with low microwave frequency and additional fuel injection is the more treatment of airflow rate. The treatment volume can be easily enhanced by increasing size of the reaction chamber and adding more fuel. Therefore, there will be no technical problem to extend the treatment volume to 100,000 lpm.

Although this embodiment is the apparatus for elimination of airborne toluene gas and airborne soot powders, the invention is not limited to the use of the elimination of toluene gas and soot powders. Without departing from the spirit of the invention, numerous other rearrangements, modifications and variations of the present invention are possible in light of the foregoing teachings. It is therefore to be understood that within the scope of the appended claims, the invention may be practiced otherwise than as specifically described.

What is claimed is:

1. An apparatus for eliminating chemical and biological warfare agents in air, said apparatus comprising:
(a) a microwave plasma torch system that provides a high-temperature plasma torch in a discharge tube;
(b) a fuel injection system that injects hydrocarbon fuels into said plasma torch, generates a large volume of plasma flame and maintains said plasma flame all the way to the exhaust exit;
(c) a reaction chamber connected in series to the flame exit of the microwave plasma burner consisted of said fuel injection system so that said plasma flame from said flame exit enters said chamber; and
(d) an air supply system that supplies the contaminated air into said reaction chamber through several input ports to eliminate said warfare agents in the carrier gas by exposure to said plasma flame in said reaction chamber.

2. In the apparatus according to claim 1, wherein said reaction chamber consists of inner and outer compartments separated by slits in tangential direction along said inner compartment wall.

3. In the apparatus according to claim 1, wherein said input ports of the contaminated air are attached to said outer compartment in tangential direction along said reaction chamber wall.

4. In the apparatus according to claim 1, wherein the other end of said input ports are attached to said air supply system with the suction fan unit for injection of air contaminated with said agents, and wherein the suction fan unit functions as a vacuum cleaner collecting contaminants settled on surfaces to be decontaminated.

5. In the apparatus according to claim 5, wherein size of said reaction chamber is determined according to the airflow rate to be purified.

6. A process for eliminating toxic materials in an air stream by exposure to high-temperature plasma flame generated from a microwave plasma burner, comprising:
(a) forming an atmospheric-pressure plasma torch in a discharge tube by electromagnetic waves from a magnetron with the help of an ignition system,
(b) injecting hydrocarbon fuels into said plasma torch, which generate a large volume of high-temperature plasma flame and maintain said plasma flame all the way to exhaust exit,
(c) flowing air contaminated with said toxic materials through input ports so that said air enters the outer compartment of the reaction chamber, swirls in said outer compartment and is preheated,
(d) passing said air through slits from said outer compartment to inner compartment of said reaction chamber to swirl said air in said inner compartment,
(e) oxidizing and burning out said toxic materials in air by oxygen radicals and hot gases generated in said plasma flame inside said inner compartment, and
(f) discharging said air purified by said plasma flame through exhaust exit.

7. In the process according to claim 6, wherein said toxic materials are the chemical and biological warfare agents, the volatile organic compounds, and soot from diesel engines or diesel combustion devices.

8. In the process according to claim 6, wherein said electromagnetic waves have frequency in range of 500 MHz˜10 GHz and power in range of 0.6˜15 kW.

9. In the process according to claim 6, wherein said hydrocarbon fuels are in gaseous or liquid state, which can be methane, ethane, propane, butane, kerosene, diesel and gasoline.

10. In the process according to claim 6, wherein flow rate of said air contaminated with said toxic materials is in the range of 1000˜100,000 liters per minute.
